(19) United States
(12) Patent Application Publication
(10) Pub. No.: US 2006/0115182 A1
(43) Pub. Date: Jun. 1, 2006

(54) System and method of intensity correction

(76) Inventors: Yining Deng, San Mateo, CA (US); D. Amnon Silverstein, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/001,228

(22) Filed: Nov. 30, 2004

(51) Int. Cl. G06K 9/36

(52) U.S. Cl. 382/284

(57) ABSTRACT

A method of intensity correction of at least two frames, each frame comprising a sequence of at least two images, each image at a different image position in the sequence and each pair of adjacent images having an overlap region. The method includes selecting an image at a same image position in each frame as a reference image. A set of global intensity transformations is determined, one global intensity transformation for all pairs of adjacent images at corresponding pairs of adjacent images positions of all frames, wherein the global intensity transformations are relative to the reference images. Each global intensity transformation is applied to each pixel of one image at each corresponding pair of adjacent image positions.

### CROSS-REFERENCE TO RELATED APPLICATIONS

This application is related to U.S. patent application Ser. No. ______, Docket No. 200407849-1, filed concurrently herewith, entitled SYSTEM AND METHOD OF ALIGNING IMAGES FROM MULTIPLE CAPTURING DEVICES, which is assigned to the assignee of the present invention, and is hereby incorporated by reference herein.

### BACKGROUND

Panoramic stitching is a process that aligns and stitches together partially overlapping images of a same scene which are taken by one or more cameras to obtain a single panoramic image of the scene. When multiple cameras are used, the cameras are typically positioned at different viewing angles at a center of the scene and carefully calibrated so as to provide overlaps between the different views of the scene.

When initially acquiring the individual images, the camera or cameras is/are adjusted so as to have as closely as possible the same settings, including exposure settings, for each of the acquired images. Nevertheless, there are often differences in intensity between the acquired images due to a variety of factors including changes in light conditions over time and to nearly inherent differences in tolerances between cameras. As a result, even though the images may be nearly perfectly aligned when they are stitched together, the single panoramic image will often exhibit distinct edges at the stitching boundaries of the individual images due to the different intensities of the overlapping images. This is particularly troublesome for panoramic movies/videos where multiple cameras are typically employed, wherein intensities can vary between images of a same frame acquired by different cameras and between images of different frames acquired by a same camera, resulting in a “flickering” effect when the movie is viewed.

### SUMMARY

In one embodiment, the present invention provides a method of intensity correction of at least two frames, each frame comprising a sequence of at least two images, each image at a different image position in the sequence and each pair of adjacent images having an overlap region. The method includes selecting an image at a same image position in each frame as a reference image. A set of global intensity transformations is determined, one global intensity transformation for all pairs of adjacent images at corresponding pairs of adjacent images positions of all frames, wherein the global intensity transformations are relative to the reference images. Each global intensity transformation is applied to each pixel of one image at each corresponding pair of adjacent image positions.

### BRIEF DESCRIPTION OF THE DRAWINGS

FIG. 1A illustrates generally an example of an unaligned shot of a panoramic movie/video.

FIG. 1B illustrates generally an example of overlapping images of a frame of images from the shot of FIG. 1A.

FIG. 1C illustrates generally the shot of FIG. 1A after alignment.

FIG. 2 is a flow diagram illustrating generally a process for correcting intensity between multiple images of multiple frames of a panoramic movie/video according to one exemplary embodiment of the present invention.

FIG. 3 is a flow diagram illustrating a process for determining a linear transformation for correcting intensity between images according to one embodiment of the present invention.

FIG. 4 is a graph of an illustrative example of linear correction of pixel intensities of an image.

FIG. 5 is a graph of an illustrative example of non-linear correction of pixel intensities of an image.

FIG. 6 is a graph illustrating example non-linear corrections curves for correcting pixel intensities of an image according to one exemplary embodiment of a non-linear intensity transformation according to the present invention.

FIG. 7 is a flow diagram illustrating a process for determining a non-linear transformation for correcting intensity between images according to one embodiment of the present invention.

FIG. 8 illustrates generally another example of an aligned shot of a panoramic movie/video.

FIG. 9 is a block diagram illustrating a processing system for correcting intensity between multiple images of multiple frames of a panoramic movie/video according to one exemplary embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

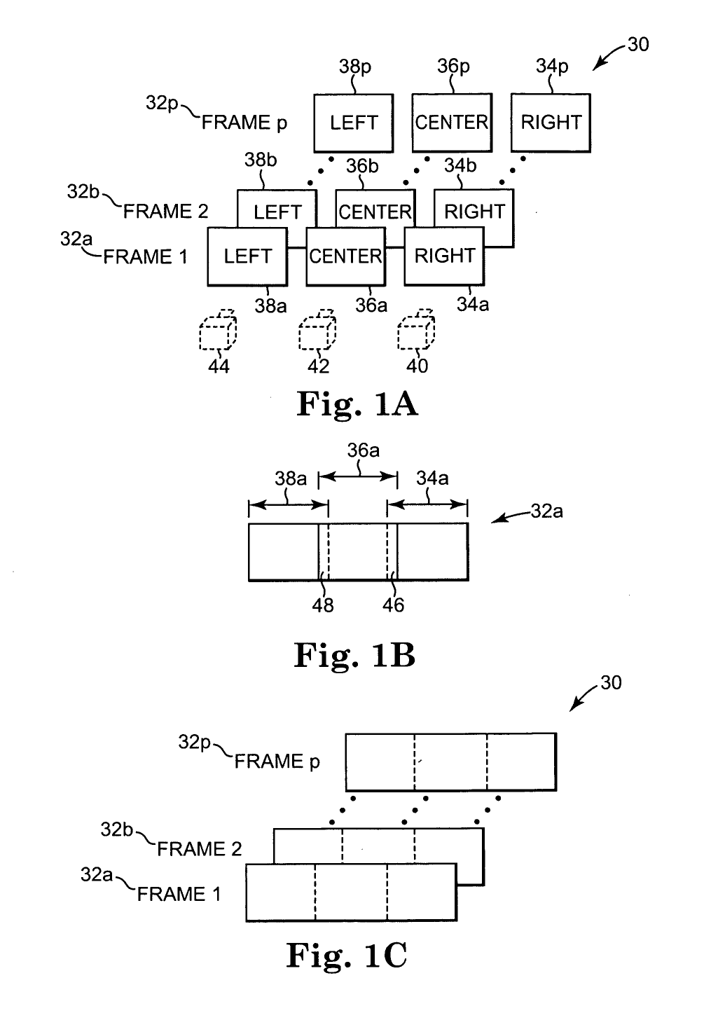

FIG. 1A illustrates generally an example of a shot 30 of a panoramic movie/video comprising a sequence of frames, illustrated as frames 32a through 32p. Each frame 32 of shot 30 comprises a sequence of three images, with each image being at a different position in the sequence. As illustrated, each frame 32 comprises an image 34 in a right image position, an image 36 in a center image position, and an image 38 in a left image position. When making a panoramic video or movie, three cameras are often employed, such as cameras 40, 42 and 44, with each camera providing one image of the sequence of each frame 32. As illustrated, cameras 40, 42, and 44 respectively provide right image 34, center image 36, and left image 38 of each frame 32, such as images 34a, 36a, and 38a, respectively, of frame 32a.

The cameras are typically located at a center of the panoramic scene and are positioned at different angles so that images at adjacent positions in the sequence of images of each frame 32 overlap one another. As such, as illustrated by FIG. 1B, center image 36a and right image 34a and center image 36a and left image 38a have respective region of overlapping pixels 46 and 48. To create a panoramic video, the images of each frame 32 are aligned and subsequently stitched together so that the three images of each frame together form a single composite image, or panoramic image, of the scene as illustrated by FIG. 1C.

To align the a sequence of overlapping images to create a panoramic image, such as images 34a, 36a, and 38a of frame 32a, an alignment transformation is determined for each pair of overlapping images in the sequence. Each alignment transformation generally corresponds to one image of the pair of overlapping images and represents a mapping between of the pixels of the pair of overlapping images to a same coordinate system. When applied to one image of the pair, the alignment transformation shifts the coordinates of the pixels of the image such that the pair of images and the corresponding overlap region are in alignment. An example of an alignment system and method suitable for aligning the images of a sequence frames each comprising a sequence of images is described by U.S. patent application Ser. No. ______, Docket No. 200407849-1, entitled SYSTEM AND METHOD OF ALIGNING IMAGES, which was incorporated herein by reference above. However, as mentioned earlier, even though the images of each frame, such as images 34a, 36a, and 38a of frame 32a, may be nearly perfectly aligned, when stitched together to form a panoramic image, the panoramic image will often exhibit distinct edges at the stitching boundaries of the individual images due to one or more factors such as different exposures, camera processing, and different development/aging of the individual images.

FIG. 2 is a flow diagram illustrating a generally a process 100 according to one embodiment of the present invention for correcting intensity differences between multiple overlapping images of multiple frames which are combined to form a panoramic movie/video, such that the panoramic movie/video has a uniform appearance. Process 100 is described below with respect to frame 30 as illustrated by FIG. 1A through FIG. 1C.

Process 100 begins at 102, where frames 32a through 32p of shot 30 are received from an alignment process, such as that described above, wherein the alignment transformation of each pair of adjacent images has been determined such that the adjacent images and corresponding overlap regions of each frame, such as images 34a, 36a, and 38a of frame 32a, are in alignment. At 104, a mapping of the overlap regions between each overlapping pair of adjacent images of each frame is determined. This information is readily available as the overlap regions are generally determined by the alignment process and the mapping of the overlap regions is easily determined since the coordinates of all pixels in each image of each frame are mapped according to a same coordinate system.

At 106, a reference image is chosen for each frame of images of shot 30. The reference image is the image in each frame relative to which, either directly or indirectly, the intensity of the remaining images of the frame will be corrected. The reference image can be any image in the sequence of images of each frame, so long as the image position of the selected reference image is the same for each frame of the shot. However, because any errors that may occur in intensity correction are likely to be compounded the farther a given image is away from the reference image (as will become apparent in the following description), the selected reference image is preferably at an image position that is at or near a center of the sequence of images of each frame. Thus, in the illustrated example, the selected reference image is at the center image position of each frame, such as image 36a of frame 32a.

At step 108, a set of global intensity transformations is determined for shot 30, one global intensity transformation for all pairs of adjacent images at corresponding pairs of adjacent image positions of all frames of the shot. Each global intensity transformation is based on optimizing a value of a function representative of the relative values of a desired image parameter between corresponding pixels in the overlap region of pairs of adjacent images at selected pairs of corresponding adjacent image positions, wherein each global intensity transformation is relative to the selected reference image.

An intensity transformation is a value or function, that when applied to one image of a pair of adjacent images corrects the intensity of the one image so that the intensities of the pair of adjacent images is substantially matched. In one embodiment, the global intensity transformations correct intensity based on the intensities of individual color channels of pixels in the overlap region. In one embodiment, the global intensity transformations correct intensity based on the average intensities of pixels in the overlap region. The determination of global intensity transformation values will be described in greater detail below.

In the illustrated example, a first global intensity transformation is determined for all pairs of adjacent images in the right and center image positions of all frames, 32a through 32p, and a second global intensity transformation is determined for all pairs of adjacent images in the left and center image positions of all frames, 32a through 32p. In one embodiment, the first and second global intensity transformations are based respectively on optimizing a value of a function representative of the relative values of a desired image parameter between corresponding pixels in the overlap region of all pairs of images at the right-and-center and left-and-center image positions of all frames, 32a through 32p.

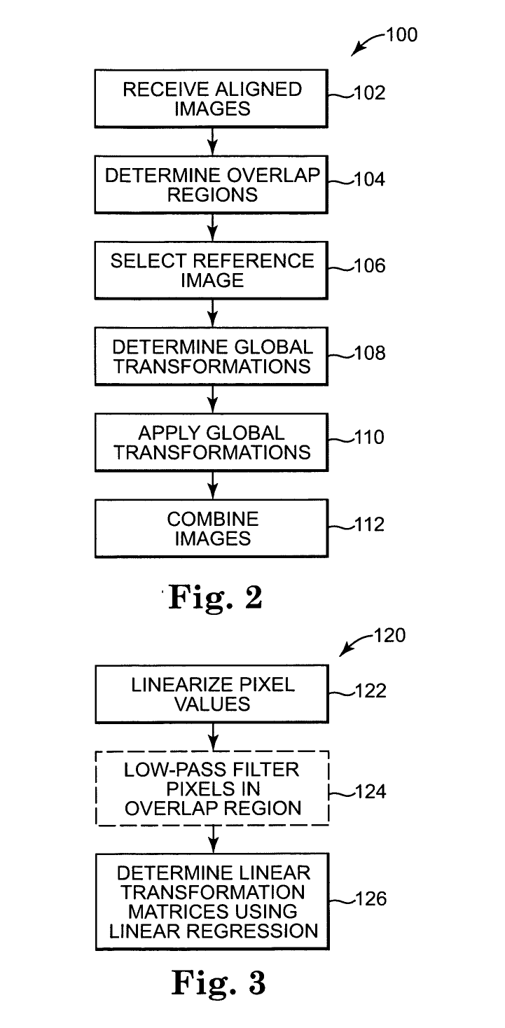

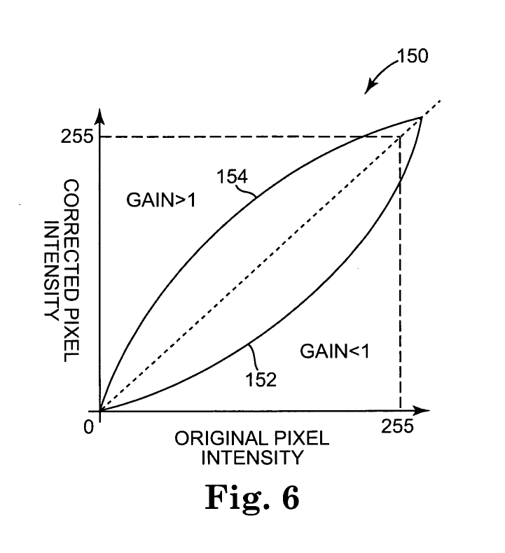

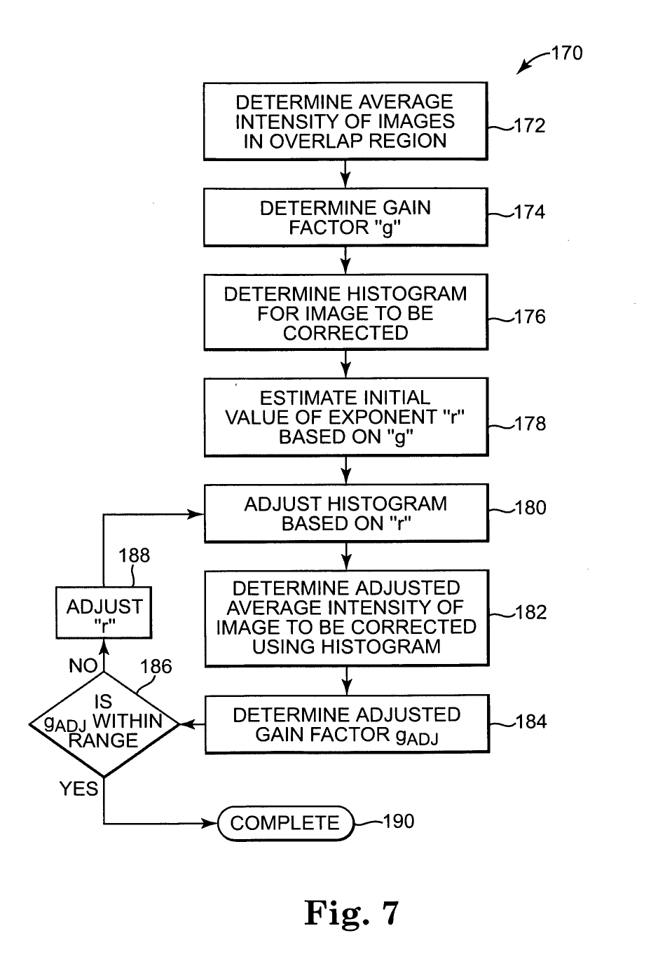

In one embodiment, the global transformations comprise linear transformations, as will be illustrated in greater detail below by FIG. 3. In one embodiment, the global transformations comprise non-linear transformations, as will be illustrated in greater detail below by FIG. 6 and FIG. 7.

At step 110, the first and second global intensity transformations are respectively applied to every pixel in each image in the right image position, images 34a through 34p, and each image in the left images position, images 38a through 38p, of all frames 32a through 32p of shot 30. In this fashion, the intensity of the left image and right image of each frame are adjusted relative to, the corresponding center image, so as to better match the intensity of the center image. After application of the global transformations at 110, the images of each frame, 32a through 32p, are stitched together at 112 so that each frame form a single panoramic image, as illustrated by FIG. 1C.

Adjusting the intensity of on an image results in an adjustment to the color of the image. Intensity can be adjusted so as to uniformly adjust each color channel of a pixel or to individually adjust the color of each color channel. By employing global transformations at corresponding pairs of images across all frames of the shot, such as frames 32a through 32p of shot 30, methods of intensity correction according to embodiments of the present invention, such as process 100, reduce flicker in panoramic movies/video by providing smoother and more consistent intensities between frames.

FIG. 3 is a flow diagram of a process 120, according to one embodiment of the present invention, employing linear transformation techniques to determine a set of linear global intensity transformations, as described generally at 108 of FIG. 2. As with process 100 of FIG. 2, process 120 is described with respect to shot 30 of FIG. 1.

Process 120 begins at 122 where the pixel values of the images of each frame are adjusted to have linear values by correcting for any gamma adjustment that may have been made to the pixel values. Gamma adjustment, as is commonly known to those skilled in the art, is a technique used to adjust pixel values so as to be properly displayed on monitors that generally employ a non-linear relationship between pixel values and displayed intensities. Typically, the gamma adjustment comprises raising the pixel value to a power, wherein the power to which the pixel value is raised is referred to as gamma. While different systems may employ different gamma values, digital cameras typically employ a gamma of 2.2. Linearizing the pixel values to correct for gamma adjustment involves applying the inverse of the above described non-linear gamma adjustment process such that the pixel values have a linear relationship.

In one embodiment, process 100 optionally includes low pass filtering the overlapping region of each image, as illustrated by the dashed block at 124. Low pass filtering can be performed using several techniques known to those skilled in the art. Low pass filtering has the effect of “blurring” distinct boundaries in images in order to achieve a better correspondence between corresponding pixels in the overlap region that may be slightly misaligned.

At 126, in one embodiment, a linear transformation is determined between each pair of adjacent images of each frame using a linear regression based on the corresponding pixels in the overlap region. Each pixel in the overlap region has a set of color values, with one intensity value for each color channel. For example, each pixel may have three color intensity values: one for a red channel, one for a green channel, and one for a blue channel (i.e. its RGB values). Using linear regression techniques, a transformation matrix is determined for each pair of adjacent images based on the RGB values of the corresponding pixels in overlap regions, such that when the RGB values of pixels in the overlap region of one image of the pair of overlapping images is multiplied by the transformation matrix, the RGB values are adjusted so as to be substantially equal to the RGB values of the corresponding pixels of the other image of the pair of overlapping images. In one embodiment, the transform value for each color channel of the transformation matrix is selected based on minimizing the mean square error between the corresponding color values of corresponding pixels in the overlap region.

With respect to the illustrative shot 30 of FIG. 1A, a transformation matrix (T) is determined for each pair of adjacent images at each pair of adjacent image positions of each frame. For example, a matrix T(R,C)₁ is determined for first frame 32a such that when the pixels in the overlap region of right image 34a are multiplied by T(R,C)₁, the RGB values substantially match the RGB values of the corresponding pixels in the overlap region of center image 36a. This is illustrated by Equation I below:
[R_{R}G_{R}B_{R}]₁*[T(R,C)₁]=[R_{C}G_{C}B_{C}] ₁; Equation I:

where [R_{R} G_{R} B_{R}]₁=RGB values of right image 34a;

[T(R,C)₁]=Transformation matrix for right image 34a; and

[R_{C} G_{C} B_{C}]₁=RGB values of center image 34a.

Similarly, a matrix T(L,C)₁ is determined for frame 32a such that when the pixels in the overlap region of left image 38a are multiplied by T(L,C)₁, the RGB values substantially match the RGB values of the corresponding pixels in the overlap region of center image 36a. The above process is repeated for each frame of shot 30, concluding with the determination of transformation matrixes T(R,C)ₚ and T(L,C)ₚ for the final frame, 32p.

Global transformation matrixes, T(R,C)_{Global} and T(L,C)_{Global}, are then determined for each pair of corresponding adjacent image positions of all frames, 32a through 32p, of shot 30. In one embodiment, T(R,C)_{Global} and T(L,C)_{Global} respectively comprise an average of all of the transformation matrixes T(R,C)₁ through T(R,C)ₚ for the images 34a through 34p and an average of all of the transformation matrixes T(L,C)₁ through T(L,C)ₚ for the images 38a through 38p of shot 30. As such, in one embodiment, global intensity transformation matrixes T(R,C)_{Global} and T(L,C)_{Global} are provided respectively by the following Equations III and IV:

$$Equation II \text{:}$$

$$T ( R , C ) Global = \frac{{\sum }_{x = 1}^{p} {T ( R , C )}_{x}}{p} ;$$

$$Equation \text{III} \text{:}$$

$$T ( L , C ) Global = \frac{{\sum }_{x = 1}^{p} {T ( L , C )}_{x}}{p} .$$

After determining global transformation matrices T(R,C)_{Global} and T(L,C)_{Global}, the global transformation matrices are applied to the corresponding image of each frame of shot 30 as illustrated at 110 by process 100 of FIG. 2. For example, every pixel of images 34a through 34p, not just pixels in the overlap regions with images 36a through 36p, are multiplied by T(R,C)_{Global}. Likewise, every pixel of images 38a through 38p, not just pixels in the overlap regions with images 36a through 36p, are multiplied by T(L,C)_{Global}. As such, the intensity of the entire image in both the right and left image positions of every frame are consistently corrected so as to better match the image in the corresponding center image position.

Alternatively, in lieu of determining the global transformation matrixes based on an average of the transformation matrixes of each of the corresponding pairs of adjacent image positions of each frame 32a through 32p of shot 30, the global transformation matrices are based on an average of transformation matrices of selected frames of shot 30. In such a scenario, it preferred that the selected frames be representative of a broad range of colors so that the global transformation matrices correct well over the color spectrum. Such an approach takes less time and requires less memory than computing global matrices based on every frame. In another embodiment, the global matrices T(R,C)_{Global} and T(L,C)_{Global} can be determined directly from linear regressions based respectively on the pixels in the overlap region between the right and center images and between the left and center images of all frames of shot 30.

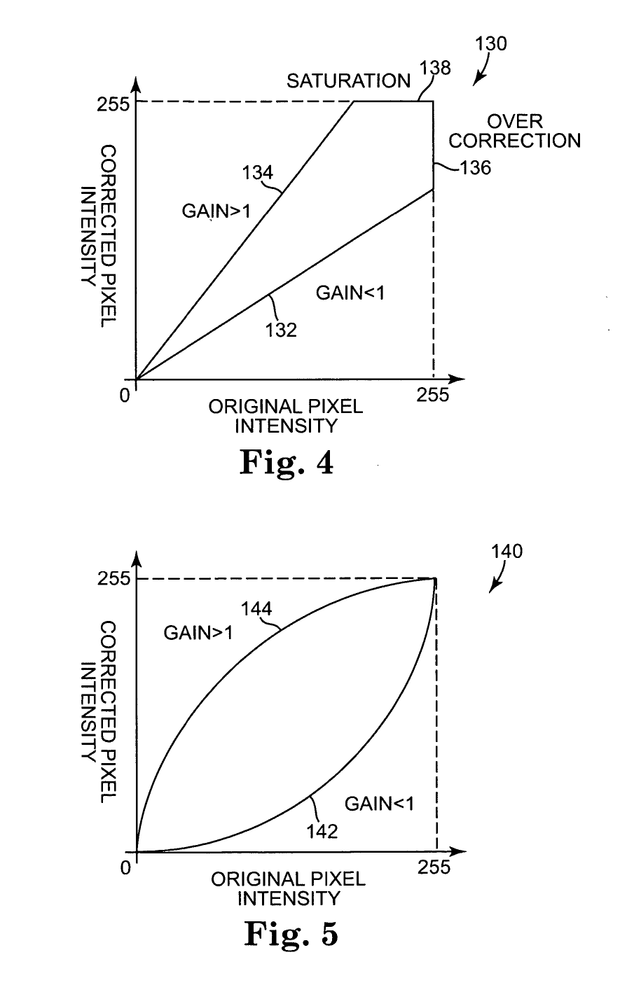

While the linear transformation technique in accordance with process 200 described above is effective at matching the intensity differences between images, often there are many factors effecting intensity such that intensity differences between images are not able to be modeled linearly. For example, cameras often employ post processing that corrects color and contrast that makes intensity differences (e.g. gains) between two images difficult to model with a single equation. Such post processing causes intensity and color shifts even when intensity settings of the camera remain constant, such as when the camera is set to panoramic mode. Furthermore, as illustrated below by FIG. 4, linear correction of intensity differences can sometimes result in saturation and in over correction of image intensity.

FIG. 4 is a graph 130 of an illustrative example of linear correction of pixel intensities of an image, wherein the original pixel intensity is indicated along the x-axis and the corrected intensity is indicated along the y-axis and illustrated by curves 132 and 134. Cameras typically clip pixel intensities at a level of 255, even if the intensity of the object being photographed, such as the sky, for example, has an actual intensity of say, 270. If, when trying to match the intensity of this image to another image the intensity needs to be reduced and a linear correction having a gain factor of say, 0.9, is employed, the pixel will be corrected from a value of 255 to a value of 229.5 when more accurately the pixel should be correct to a value of 243 from the value of 270. This is an example of what is referred to as an over correction of the pixel value, wherein pixels having high values are over corrected relative to pixels having lower values.

Conversely, when a linear correction having a gain factor of greater than “1” is employed to increase the intensity of an image to match that of another image, pixels having lower values will be adjusted while pixels having higher levels will be corrected to a maximum value of 255 even though they should be corrected to a value greater than 255. This is an example of what is referred to as saturation, wherein pixels having higher values are under corrected relative of pixels having lower values. Curve 132 illustrates the effect of over correction at 136 when the gain factor of the linear correction is less than “1”, and curve 134 illustrates the effect of saturation at 138 when the gain factor of the linear correction is greater than “1.” One approach for correcting image intensity that reduces such saturation and over correction effects is to employ non-linear correction of pixel intensities.

FIG. 5 is a graph 140 of an illustrative example non-linear correction of pixel intensities of an image, with the original pixel intensity being indicated along the x-axis and the corrected pixel intensity being indicated along the y-axis. Curve 142 represents a non-linear intensity correction curve associated with an example non-linear transformation when a gain factor for correcting pixel intensity is less than one (i.e. when image intensity needs to be reduced). Curve 144 represents a non-linear intensity correction curve associated with an example non-linear transformation when a gain factor for correcting pixel intensity is greater than one (i.e. when image intensity needs to be increased). As illustrated, the ends of curves 142 and 144 are fixed at their endpoints. While the example non-linear transformation represented by curves 142 and 144 reduces saturation and over correction effects of pixels having higher intensity levels, pixels having mid-range intensity levels are over corrected relative to pixels having intensity levels in the upper and lower ranges.

FIG. 6 is a graph 150 illustrating example non-linear correction curves for correcting pixel intensities of one exemplary embodiment of a non-linear transformation according to the present invention. The non-linear transformation comprises an exponential function illustrated by Equation IV below:
p_{corrected}=(pᵢₙᵢₜᵢₐₗ)^{r}; Equation IV:

where
p_{corrected}=is the corrected pixel intensity;
pᵢₙᵢₜᵢₐₗ=is the initial pixel intensity; and
r=is a “correction” exponent.
   Curve 152 represents a non-linear intensity correction curve associated with an example non-linear transformation when a gain factor for correcting pixel intensity is less than one (i.e. when image intensity needs to be reduced). Curve 154 represents a non-linear intensity correction curve associated with an example non-linear transformation when a gain factor for correcting pixel intensity is greater than one (i.e. when image intensity needs to be increased).

As illustrated by graph 150, curves 152 and 154 exemplifying a non-linear transformation according to the present invention represent a compromise between the linear transformation represented by graph 130 and the non-linear transformation represented by graph 140. Although a certain amount of saturation and over correction occurs at the upper end of the range of pixel intensity levels, it much less than that occurring with the linear transformation represented by graph 130, and over correction of the pixel having mid-range intensity levels is less than that occurring with the non-linear transformation represented by graph 140.

FIG. 7 is a flow diagram of a process 170, according to one exemplary embodiment of the present invention, employing non-linear transformation techniques to determine a non-linear transformation, such as that represented by graph 150 of FIG. 6 and as described generally at 108 of FIG. 2. Process 170 is described with respect to shot 30 of FIG. 1.

Process 170 begins at 172, where the average pixel intensity (I) is determined for pixels in the overlap region of each image of a pair of adjacent images for which a non-linear transformation is being determined. For example, when correcting the intensity of image 34a in the right image position relative to the image 36a in the center image position of frame 32a, the average pixel intensity (I₁) of pixels in the overlap region of image 34a is determined and the average intensity (I₂) of pixels in the overlap region of image 36a is determined. At 174, a gain factor (g) is determined, wherein the gain factor is determined by the following Equation V below:
g=I₁/I₂. Equation V:

At 176, a histogram of the pixel intensities of all pixels of the image to be corrected is determined. In the illustrative example, a histogram of pixel intensities of all pixels of image 34a is determined. Such a histogram, as commonly known to those skilled in the art, is a statistical model representative of the image that summarizes the number of pixels at each of the possible pixel intensity levels.

At 178, an initial estimate is determined for the correction exponent “r” of Equation IV described above. At 180, the histogram of the image to be corrected (image 34a in the illustrative example) is corrected based on the value of the correction exponent “r” and according to non-linear function of Equation IV. At 182, a corrected average pixel intensity of the image to be corrected (I₂_{_{—}}_{Corrected}) is determined using the corrected histogram determined at 182.

At 184, an adjusted gain factor (g_{ADJ}) is determined using the corrected average pixel intensity according to Equation VI below:
g_{ADJ}=I₁/I₂_{_{—}}_{Corrected}. Equation VI:
At 186, the value g_{ADJ} of is evaluated. After the histogram is corrected based on the value of the correction exponent “r”, the value of I₂_{_{—}}_{Corrected} should begin to approach the value of I₁, and the value of g_{ADJ} should begin to approach a desired value of “1”. As such, at 186, it is queried whether the value of g_{ADJ} is within a desired range (+/−) of “1.”

If the answer to the query at 186 is “no”, process 170 proceeds to 188. At 188, the value of the correction exponent “r” is adjusted based on the how much the value of g_{ADJ} varies from “1”. The process of 180 through 184 is then repeated based on the adjusted value of correction exponent “r”. In one embodiment, the value of correction exponent “r” is adjusted using a bisection method that divides the search range for “r” by half at each iteration. If the answer to the query at 186 is “yes”, process 170 is complete as illustrated at 190.

Process 170 is repeated for each pair of adjacent images of each pair of adjacent image positions of every frame 32a through 32p of shot 30. As such, a correction exponent “r” is determined for each pair of adjacent images in the right and center image positions of each frame 32a through 32p, beginning with correction exponent r(R,C)₁ for images 34a and 36a of frame 32a and ending with correction exponent r(R,C)ₚ for images 34p and 36p of frame 32p. Likewise, a correction exponent “r” is determined for each pair of adjacent images in the left and center image positions of each frame 32a through 32p, beginning with correction exponent r(L,C)₁ for images 38a and 36a of frame 32a and ending with correction exponent r(L,C)ₚ for images 38p and 36p of frame 32p.

A pair of global correction exponents r(R,C)_{Global} and r(L,C)_{Global} are determined respectively for each pair of adjacent images in the right and center image positions and for each pair of adjacent images in the left and center images positions of every frame 32a through 32p of shot 30. In one embodiment, r(R,C)_{Global} and r(L,C)_{Global} respectively comprise an average of all the correction exponents r(R,C)1 through r(R,C)p for images 34a through 34p and an average of all the correction exponents r(L,C)1 through r(L,C)p for images 38a through 38p. As such, in one embodiment, global correction exponents r(R,C)_{Global} and r(L,C)_{Global} are provided respectively by the following Equations VII and VIII:

$$Equation VII \text{:}$$

$$r ( R , C ) Global = \frac{{\sum }_{x = 1}^{p} {r ( R , C )}_{x}}{p} ;$$

$$Equation VIII \text{:}$$

$$r ( L , C ) Global = \frac{{\sum }_{x = 1}^{p} {r ( L , C )}_{x}}{p} .$$

After determining global correction exponents r(R,C)_{Global} and r(L,C)_{Global}, the global correction exponents are applied to the corresponding image of each frame of shot 30 as illustrated at 110 by process 100 of FIG. 2. For example, the intensity level every pixel of images 34a through 34p, not just pixels in the overlap regions with images 36a through 36p, is raised to the power of the global correction exponent r(R,C)_{Global}, according to Equation IV. Likewise, the intensity level of every pixel of images 38a through 38p, not just pixels in the overlap regions with images 36a through 36p, are raised to the power of the global correction exponent r(L,C)_{Global}. As such, the intensity of the entire image in both the right and left image positions of every frame are consistently corrected so as to better match the image in the corresponding center image position.

Alternatively, in lieu of determining the global correction exponents r(R,C)_{Global} and r(L,C)_{Global} based on an average of the correction exponents of each of the corresponding pairs of adjacent image positions of each frame 32a through 32p of shot 30, the global correction exponents are based on an average of correction exponents of selected frames of shot 30. In such a scenario, it preferred that the selected frames be representative of a broad range of colors so that the global correction exponents correct well over the color spectrum. Such an approach takes less time and requires less memory than computing global correction exponents based on every frame. In another embodiment, the global matrices r(R,C)_{Global} and r(L,C)_{Global} can be determined directly from non-linear regressions based respectively on the pixels in the overlap region between the right and center images and between the left and center images of all frames of shot 30.

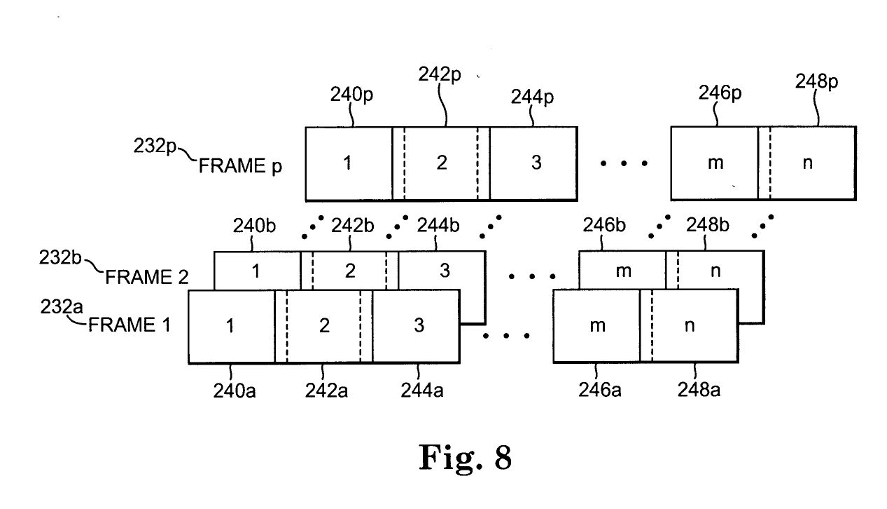

While process 100 of FIG. 2, process 120 of FIG. 3, and process 170 of FIG. 7 were described above with regard to a panoramic shot comprising frames having three images, such as shot 30 illustrated by FIGS. 1A through 1C, these processes can apply to shots comprising any number of images, such as shot 230 illustrated by FIG. 8. Shot 230 comprises a sequence of “p” frames, 232a through 232p, with each frame 232 comprising a sequence of “n” images, with each of the images being at one of “n” image positions, such as images 240a through 248a of frame 232a.

Similar to that described above with respect to shot 30, a set of global intensity transformations is determined, one global intensity transformation for all pairs of adjacent images at corresponding pairs of adjacent image positions of all frames 232a through 232p of shot 230. As such a set of global intensity transformations (GET's) is determined, beginning with GET(1,2)_{Global} and ending with GET(m,n)_{Global}, respectively corresponding to the first adjacent pair of image positions and to the final pair of adjacent image positions of each frame 232a through 232p of shot 230. As described above, the GET's are determined relative to a reference image. Also as described above, to improve the accuracy of the alignment process, it is desirable that the reference image be at a same image position in each frame and be at an image position that is substantially at the center of the sequence of images of each frame.

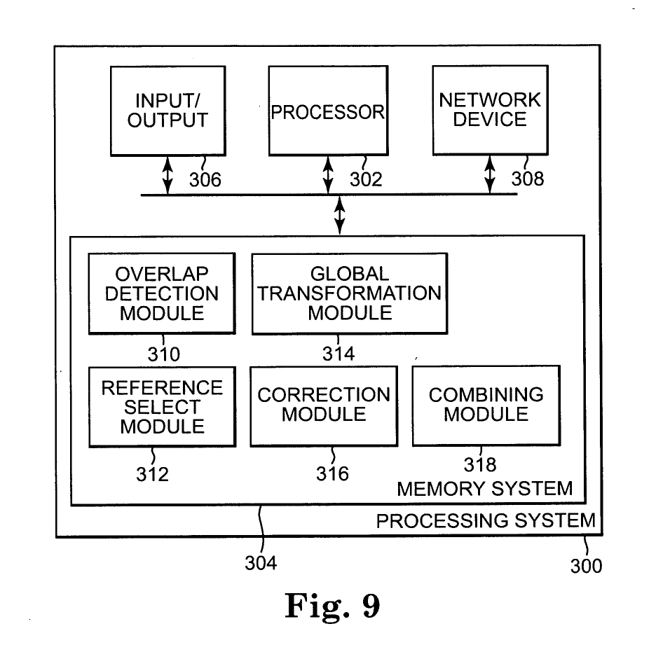

FIG. 9 is a block diagram illustrating a processing system 300 configured to align images of frames of panoramic movies/videos, such as those illustrated by FIG. 1A. Processing system 300 comprises a processor 302, a memory system 304, an input/output 306, and a network device 308. Memory system 304 comprises an overlap detection module 310, a reference select module 312, a global transformation module 314, a correction module 316, and a combining module 318. Processing system 300 comprises any type of computer system or portable or non-portable electronic device. Examples include desktop, laptop, notebook, workstation, or server computer systems. Examples of electronic devices include digital cameras, digital video cameras, printers, scanners, mobile telephones, and personal digital assistants.

In one embodiment, overlap detection module 310, reference select module 312, global transformation module 314, correction module 316, and combining module 318 each comprise instructions stored in memory system 304 that are accessible and executable by processor 302. Memory system 304 comprises any number of types of volatile and non-volatile storage devices such as RAM, hard disk drives, CD-ROM drives, and DVD drives. In other embodiments, each of the modules 310 through 320 may comprise any combination of hardware and software components configured to perform the functions described herein.

A user of processing system 300 controls the operation of overlap detection module 310, reference select module 312, global transformation module 314, correction module 316, and combining module 318 by providing inputs and receiving outputs via input/output unit 306. Input/output unit 306 may comprise and combination of a keyboard, mouse, display device, or other input/output device that is coupled directly, or indirectly, to processing system 300.

Overlap detection module 310, reference select module 312, global transformation module 314, correction module 316, and combining module 318 may each be stored on a medium separate from processing system 300 prior to being stored in processing system 300. Examples of such a medium include a hard disk drive, a compact disc (e.g., a CD-ROM, CD-R, or CD-RW), and a digital video disc (e.g., a DVD, DVD-R, or DVD-RW). Processing system 300 may access overlap detection module 310, reference select module 312, global transformation module 314, correction module 316, and combining module 318 from a remote processing or storage system (not shown) that comprises the medium using network device 308.

In operation, processing system 300 receives via input/output unit 306 a shot of a movie/video comprising a set of two or more frames, such as shot 30 illustrated by FIG. 1. Each frame comprises a sequence of two or more aligned images, each image at a different image position in the sequence and each pair of adjacent image positions having an overlap region. Processing system 300 executes overlap detection module 310 to determine a mapping between corresponding pixels in the overlap region of each pair of adjacent images of each frame of shot 30, such as described at 104 of process 100 of FIG. 2.

Processing system 300 then executes reference select module 312 to determine a reference image for each frame of a shot, such as described at 106 of process 100 of FIG. 2. After selecting reference images, processing system 300 executes global transformation module 314 to determine a set of global intensity transformations, one global intensity transformation for all pairs of adjacent images at corresponding pairs of adjacent image positions of all frames of a shot, such as described at 108 of process 100 of FIG. 2. In one embodiment, global transformation module 314 determines a set of linear global transformations according to process 120 of FIG. 3. In one embodiment, global transformation module 314 determines a set on non-linear global transformations according to process 170 of FIG. 7.

Process system 300 then executes correction module 318 to apply the global intensity transformations determined by global transformation module 316 to one image of the pair of images at the corresponding pair of adjacent image positions of each frame so as to substantially match the intensities of the images, such as described at 110 of process 100 of FIG. 2. Process system 300 then executes combining module 318 to stitch together to intensity corrected images of each frame so that each frame forms a single panoramic image, such as described at 112 of process 100 of FIG. 2 and as illustrated by FIG. 1C.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of intensity correction of at least two frames, each frame comprising a sequence of at least two images, each image at a different image position in the sequence and each pair of adjacent images having an overlap region, the method comprising:
selecting an image at a same image position in each frame as a reference image;
determining a set of global intensity transformations, one global intensity transformation for all pairs of adjacent images at corresponding pairs of adjacent images positions of all frames, wherein the global intensity transformations are relative to the reference images; and
applying each global intensity transformation to each pixel of one image at each corresponding pair of adjacent image positions.

2. The method of claim 1 further comprising:
determining a mapping between corresponding pixels in the overlap region of each pair of adjacent images;
wherein determining the set of global intensity transformations further comprises optimizing a value of a function representative of the relative intensity levels between corresponding pixels in the overlap region of pairs of adjacent images at corresponding pairs of adjacent image positions of selected frames.

3. The method of claim 1, wherein selecting a reference image comprises selecting an image at an image position approximately at a center of the sequence of images.

4. The method of claim 1, wherein the selected frames comprise all frames of the set of frames.

5. The method of claim 1, further comprising:
determining a local intensity transformation for the images of each pair of adjacent image positions of the selected frames, wherein each local intensity transformation is based on optimizing a value of a function representative of the relative intensity levels between corresponding pixels in the overlap region of pairs of adjacent images at corresponding pairs of adjacent image positions of selected frames, and wherein the global intensity transformations are based on the local intensity transformations for the images at the corresponding pair of adjacent image positions of the selected frames.

6. The method of claim 1, further comprising:
aligning each pair of adjacent images of each frame.

7. The method of claim 1, wherein the global intensity transformations comprise linear transformations.

8. The method of claim 7, wherein each global intensity transformation comprises a matrix.

9. The method of claim 7, wherein the global intensity transformations are determined using linear regression techniques.

10. The method of claim 9, wherein a mean square error of a linear regression of intensity values of at least one color channel between the pixels in the overlap region of pairs of adjacent images at corresponding pairs of adjacent image positions of the selected frames is optimized.

11. The method of claim 1, wherein the global intensity transformations comprise non-linear transformations.

12. The method of claim 11, wherein each global intensity transformation comprises an exponential function.

13. The method of claim 11, wherein the global intensity transformations are determined using non-linear regression techniques.

14. The method of claim 12, wherein the exponential function is based on optimizing a match between average intensity levels of pixels in the overlap region of pairs of adjacent images at corresponding pairs of adjacent image positions of the selected frames.

15. The method of claim 12, wherein determining an intensity transformation for correcting an average intensity of a first image of a pair of overlapping adjacent images to substantially match an average intensity of a second image of the pair of images comprises:
determining a first average intensity of pixels in the overlap of the first image and a second average intensity of pixels in the overlap region of the second image;
determining a gain value based on a ratio of the second average intensity to the first average intensity;
estimating an intensity correction exponent based on the gain value;
determining an adjusted first average intensity based on the intensity correction exponent;
determining an adjusted gain value based on a ratio of the adjusted first average intensity to the second average intensity; and
adjusting the intensity correction exponent based on the adjusted gain value until the adjusted gain value is within a desired range.

16. The method of claim 15, wherein determining an adjusted first average intensity includes raising an intensity level of each pixel in the overlap region of the first to the power of the intensity correction exponent.

17. The method of claim 15, wherein the intensity correction exponent is adjusted until the adjusted gain value is substantially equal to one.

18. A system for processing at least two frames, each frame comprising a sequence of at least two mages, each image at a different image position in the sequence and each pair of adjacent images having an overlap region, the system comprising:
a reference select module to select an image at a same image position in each frame as a reference image;
a global transformation module to determine a set of global intensity transformations, one global intensity transformation for all pairs of adjacent images at corresponding pairs of adjacent images positions of all frames, wherein the global intensity transformations are relative to the reference images; and
a correction module to apply each global intensity transformation to each pixel of one image at each corresponding pair of adjacent image positions.

19. The system of claim 18, further comprising an overlap detection module to determine a mapping between corresponding pixels in the overlap region of each pair of adjacent images and wherein the global transformation module determines each global intensity transformation based on optimizing a value of a function representative of the relative intensity levels between corresponding pixels in the overlap region of pairs of adjacent at corresponding pairs of adjacent image positions of selected frames.

20. The system of claim 18, further comprising an aligning module for aligning each pair of adjacent images of each frame prior to selecting an image at a same image position in each frame as a reference image.

21. The system of claim 18, further comprising a combining module for stitching together the sequence of images of each frame such that each frame forms a composite image, subsequent to applying each global intensity transformation to each pixel of one image at each corresponding pair of adjacent image positions.

22. A system comprising:
means for receiving a set of at least two frames, each frame comprising a sequence of at least two images, each image at a different image position in the sequence and each pair of adjacent images having an overlap region;
means for selecting an image at a same image position in each frame as a reference image;
means for determining a set of global intensity transformations, one global intensity transformation for all pairs of adjacent images at corresponding pairs of adjacent images positions of all frames, wherein each global intensity transformation is based on optimizing a value of a function representative of the relative intensity levels between corresponding pixels in the overlap region of pairs of adjacent at corresponding pairs of adjacent image positions of selected frames, and wherein the global intensity transformations are relative to the reference images; and
means for applying each global intensity transformation to each pixel of one image at each corresponding pair of adjacent image positions.

23. The system of claim 22, further comprising:
means for mapping between corresponding pixels in the overlap region of each pair of adjacent images.

24. The system of claim 22, further comprising:
means for aligning each pair of adjacent images of each frame.

25. The system of claim 22, further comprising:
means for determining a local intensity transformation for the images of each pair of adjacent image positions of the selected frames, wherein each local intensity transformation is based on optimizing a value of a function representative of the relative intensity levels between corresponding pixels in the overlap region of pairs of adjacent at corresponding pairs of adjacent image positions of selected frames, and wherein the global intensity transformations are based on the local intensity transformations for the images at the corresponding pair of adjacent image positions of the selected frames.

26. A computer-readable medium including instructions executable by a processing system for performing a process on a sequence of frames, each frame comprising a sequence of at least two images, each image at a different image position in the sequence and each pair of adjacent images having an overlap region comprising:
selecting an image at a same image position in each frame as a reference image;
determining a set of global intensity transformations, one global intensity transformation for all pairs of adjacent images at corresponding pairs of adjacent image positions of all frames, wherein the global intensity transformations are relative to the reference images; and
applying each global intensity transformation to each pixel of one image at each corresponding pair of adjacent image positions.

27. A method of intensity correction for a sequence of at least two images, the sequence including at least a first pair of adjacent images having an overlap region, the first pair of adjacent images including a first image and a second mage, the method comprising:
determining a first average intensity of pixels of the first image in the overlap region and a second average intensity of pixels of the second image in the overlap region;
determining a gain value based a ratio of the second average intensity to the first average intensity;
estimating an intensity correction exponent based on the gain value;
determining an adjusted first average intensity based on the intensity correction exponent;
determining an adjusted gain value based on a ratio of the adjusted first average intensity to the second average intensity; and
adjusting the intensity correction exponent based on the adjusted gain value until the adjusted gain value is within a desired range.

28. The method of claim 27, wherein determining an adjusted first average intensity includes raising an intensity level of each pixel in the overlap region of the first to the power of the intensity correction exponent.

29. The method of claim 27, wherein the intensity correction exponent is adjusted until the adjusted gain value is substantially equal to one.
